(19) United States
(12) Patent Application Publication
(10) Pub. No.: US 2011/0030635 A1
(43) Pub. Date: Feb. 10, 2011

(54) FUEL INJECTOR NOZZLE FOR REDUCED COKING

(75) Inventors: Grzegorz Siuchta, Des Plaines, IL (US); Rakesh Malhotra, Aurora, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC, Warrenville, IL (US)

(21) Appl. No.: 12/535,015

(22) Filed: Aug. 4, 2009

(51) Int. Cl. F02B 43/00; B05B 1/30; F02M 25/07

(52) U.S. Cl. 123/1 A; 239/584; 123/568.11

(57) ABSTRACT

The present invention modifies the outlet holes of a fuel injector for injecting fuel into a cylinder of an internal combustion engine. In the present invention, the outside opening of the outlet holes are modified in a manner that increases the outside opening, making the outside opening larger than the inside opening and creating an intermediate opening, which is recessed with the needle housing.

### FIELD OF THE INVENTION

This invention relates to internal combustion engines, including but not limited to needle housings for fuel injectors for use with internal combustion engines.

### BACKGROUND OF THE INVENTION

Internal combustion engines include crankcases having a plurality of cylinders. The cylinders contain pistons whose reciprocating motion due to combustion events may be transferred through a crankshaft to yield a torque output of the engine. Often, engine crankcases are made of cast metal, and include passages integrally formed therein for the transfer of various fluids from one location of the engine to another. Fluids typically transferred through passages in an engine include coolant, air, fuel, oil, and so forth.

The combustion events within engine cylinders are the result of combustion of a combustible mixture of oxygen and fuel. In modern engines, fuel is injected directly into the cylinder by a fuel injector that is operably associated with each cylinder. There are many different types of fuel injectors in use. Some fuel injectors use pressurized fuel which they inject into a cylinder, while others receive fuel at a low pressure which they then pressurize internally before injecting a quantity of the pressurized fuel into the cylinder.

FIGS. 1 and 2 illustrate a known fuel injector. This injector is also described in published U.S. patent application 2008/0290188, herein incorporated by reference. The fuel injector 100 is a unit injector capable of injecting fuel at a high pressure. The injector 100 is able to admit fuel at a low pressure and amplify the pressure of the fuel to a high pressure. The fuel injector 100 includes an actuation-fluid valve portion 102, an intensification portion 104, a needle-valve portion 106, and a needle housing portion 108.

The actuation-valve portion 102 includes a spool valve 110 that is actuated by at least one electronic (e.g. solenoid) actuator 112. During operation of the injector 100, the spool valve 110 intermittently opens to admit an actuation fluid, typically fuel or oil, which is at a high pressure. The actuation fluid is routed to the intensification portion 104 that includes an intensification piston 114. The intensification piston 114 fluidly communicates with an intensification chamber 116. An area of the intensification piston 114 that is exposed to actuation fluid is larger than an opposite area thereof that is open to the intensification chamber 116, such that the pressure of the actuation fluid is amplified in the intensification chamber 116.

At times when the spool valve 110 isolates the intensification piston 114 from actuation fluid at the high pressure, the intensification chamber 116 is usually occupied by fuel at an initial pressure. The initial pressure may be a pressure that is lower than or about equal to the high pressure of the actuation fluid. The intensification piston 114 becomes exposed to actuation fluid at the high pressure when the spool valve 110 opens. The pressure of fuel contained in the intensification chamber 116 increases to a final or injection pressure that is well above the high pressure of the actuation fluid due to the amplification effect of the intensifier piston.

Fuel at the injection pressure exits the intensification chamber 116 and travels via a nozzle supply passage 118, through the needle-valve portion 106, and into the needle housing portion 108 of the injector 100. The needle housing portion 108 includes a needle housing 120. The needle housing forms a needle cavity 122 which houses a needle valve 124. A collection cavity 126 fluidly communicates with the nozzle supply passage 118 through a feed passage 128. The collection cavity 126 is formed in the needle housing 120 and surrounds a portion of the needle 124 that is close to the needle-valve portion 106.

At times when fuel at injection pressure enters the collection cavity 126, a pressure is applied onto the needle 124 that pushes the needle toward the needle-valve portion 106 and against a spring 130 that is contained therein. When a force on the needle 124 due to fuel at the injection pressure in the collection cavity 126 surpasses a force of the spring 130, the needle valve 124 moves toward the needle-valve portion 106 and exposes one or more nozzle holes 132 to fuel in the collection cavity 126. Fuel begins exiting the injector 100 through the holes 132. This constitutes an injection event. When fuel pressure in the collection cavity 126 diminishes, the spring 130 pushes the needle 124 away from the needle-valve portion 106, and the flow of fuel through the holes 132 ceases.

Coking occurs as a result of the combustion of fuel and forms a carbonaceous solid called coke that accumulates inside the cylinders. The deposit of coke around the nozzle openings can obstruct the opening. As a result, fuel cannot be adequately injected into the engine cylinder causing lower engine performance in the form of poor acceleration, rough idling, hesitating, stalling and power loss.

The present inventors have recognized one problem encountered by some fuel injectors is coking around the nozzle outlet openings that reduces flow through the holes 132 over time and thereby reduces engine performance. For nozzles having sharp, right angle inlet openings of the holes 132, during an injection event, the fuel delivery through the nozzle creates cavitation which tends to clear coking from the nozzle outlet opening. However, higher efficiency nozzles may be required to reduce soot emissions from the engine. Efficiency is defined in this context as the ability of the nozzle hole to convert pressure energy at the inlet of the nozzle hole to kinetic energy at the exit of the nozzle hole. For a higher efficiency, the inlet openings 132a (FIG. 2A) of the holes 132 can be smoothly chamfered or radiused. The present inventors have recognized that for higher efficiency designs wherein although spray efficiency is increased, cavitation is decreased and the coke-cleaning function of the fuel delivery has a reduced effectiveness.

Additionally, the present inventors have recognized coking of injector nozzles may be exacerbated by increased levels of Exhaust Gas Recirculation (EGR), lowered intake manifold temperatures and the use of additives in low sulfur fuels all in an effort to reduce emissions.

### SUMMARY OF THE INVENTION

According to an exemplary embodiment of the invention the nozzle holes of a fuel injector for injecting fuel into a cylinder of an internal combustion engine are modified. According to exemplary embodiments of the invention, the nozzle holes have an outside opening that is expanded in size compared to the inside opening.

The fuel injector comprises an injector body that includes a needle valve held within a needle or valve housing. A feed passage fluidly connects the needle housing with a high pressure fuel source. The needle housing has a number of nozzle holes through the housing. The nozzle holes are spaced at a pre-determined distance around the circumference of the housing and allow fuel to be injected into the engine cylinders.

The nozzle holes have an inside opening and an outside opening. According to exemplary embodiments of the present invention, the outside opening is larger than the inside opening. The nozzle hole has a larger opening size from an intermediate opening to the outside opening.

According to the exemplary embodiments, the intermediate opening is recessed from an outside surface of the needle housing. The enlarged outside opening acts to protect or shield the intermediate opening from coking that occurs in the engine cylinder, and the increased size of the outside opening creates a large surface area surrounding the intermediate opening, thereby reducing the likelihood that coke will obstruct the intermediate opening and reduce fuel injector functioning.

In one embodiment of the invention, the hole is dished at the outside opening to form a curved contour, creating for example, a semi-spherical exit. In another embodiment, the hole is tapered at the outside opening to form a frusto-conical exit. Other shapes and modifications are contemplated wherein the intermediate opening recessed from the outside surface of the needle housing.

Advantageously, the frusto-conical or spherical shapes are smoothly transitioned into the outside surface of the nozzle wall and into the intermediate opening.

The shape of the nozzle holes creates an outside opening that is recessed from the outside surface of the needle housing, which increases the outside opening diameter. The recessed outside opening shields the intermediate opening from exposure to coking in the engine cylinder, and the increased diameter creates a large surface area surrounding the intermediate opening. The overall effect of the exemplary embodiment should result in reduction and prevention of coke accumulation at the intermediate opening and thereby keep the fuel injector functioning effectively for a longer period of time.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a cross-section view of a prior art fuel injector having a needle housing with a collection cavity.

FIG. 2 is a detailed cross-section view of the needle housing shown as part of the prior art injector of FIG. 1.

FIG. 2A is an enlarged sectional detail taken from a tip portion of the housing shown in FIG. 2.

FIG. 3 is an enlarged sectional of a nozzle portion of a needle housing according to one embodiment of the invention.

FIG. 4 is an enlarged sectional view taken from FIG. 3.

FIG. 5 is an enlarged sectional view similar to FIG. 4, but showing a further embodiment of the invention.

FIG. 6 is an enlarged sectional view similar to FIG. 4, but showing a still further embodiment of the invention.

### DESCRIPTION OF A PREFERRED EMBODIMENT

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

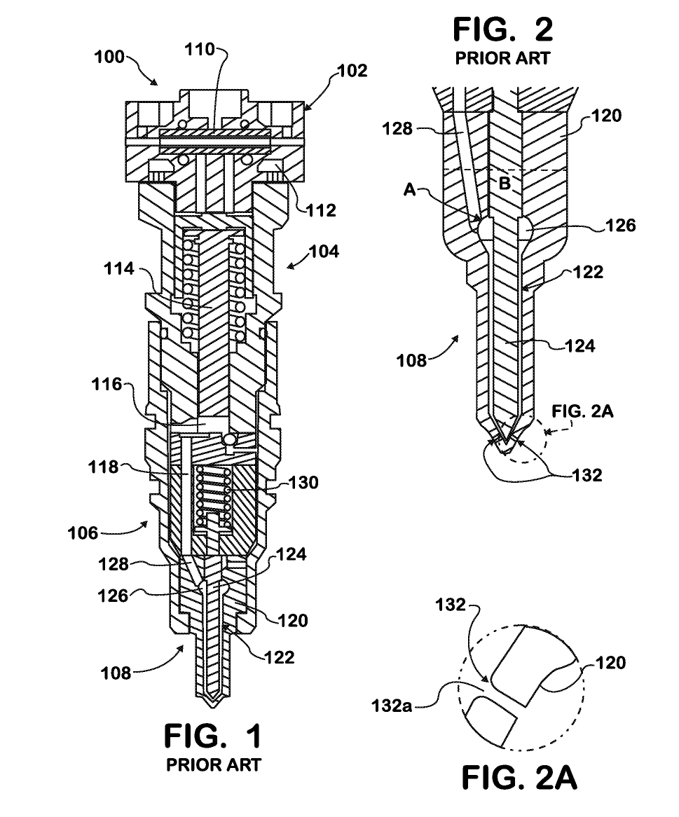

FIGS. 1 and 2 illustrate the prior art fuel injection needle. In the prior art design, coking around the nozzle holes 132 can reduce flow through the nozzle holes 132 over time and thereby reduces engine performance. The present invention should help alleviate this problem by modifying the nozzle holes 132.

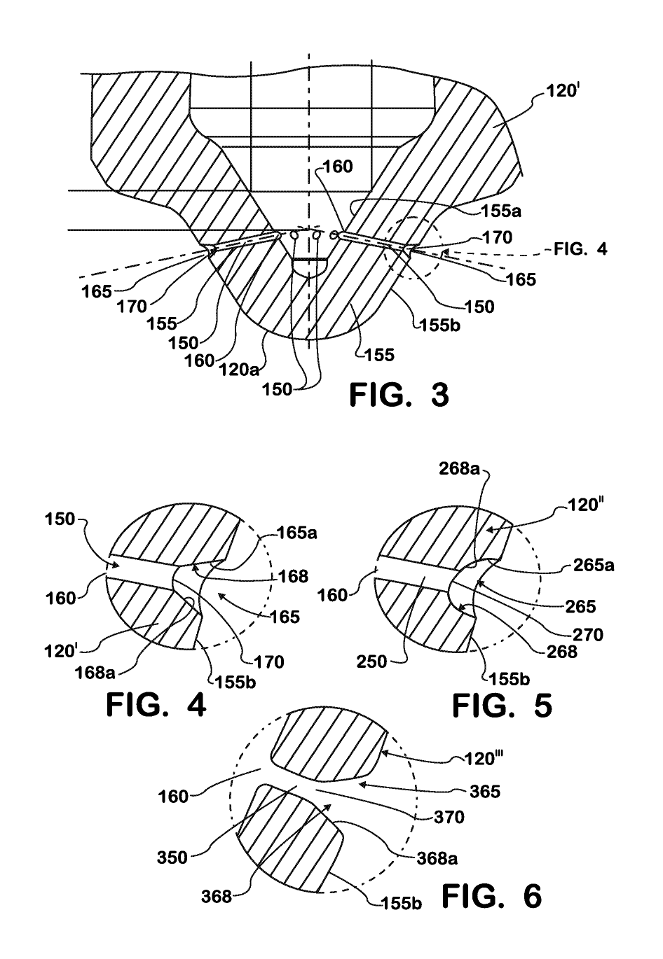

FIG. 3 illustrates an enlarged section of the tip portion of a modified needle housing 120′ according to a first embodiment of the invention. The needle housing 120′ includes a surrounding wall 155 that has nozzle holes 150 therethrough that are spaced at a pre-determined distance around the circumference of the needle housing 120′. The nozzle holes 150 have an inside opening 160 on an inside surface 155a of the wall 155 and an outside opening 165 on an outside surface 155b of the wall 155. The outside opening 165 communicates with the engine cylinder.

The inside opening 160 can be a chamfered or radiused opening similar to the opening 132a shown in FIG. 2A.

The present invention modifies the geometry of the nozzle holes by recessing the outside opening 165 from the outside surface 155b of the wall 155 thereby increasing the diameter of the outside opening 165 and creating a recessed intermediate opening 170. As a result, the modification also creates a large surface area surrounding the intermediate opening 170. The outside opening 165 acts to shield the intermediate opening 170 from being in direct contact with the coking process occurring in the engine cylinder. The overall result should be reduced coke accumulation around the outside opening 165 and within the intermediate opening 170 thereby reducing and preventing obstruction of the intermediate opening 170, resulting in more effective fuel injection over time.

FIG. 4 illustrates the nozzle hole 150 of FIG. 3. In this embodiment, the outside opening 165 has a straight taper to form a frusto-conical section 168. This new structure of the outside opening 165 increases the outside opening diameter compared to the intermediate opening 170 and creates a large surface area surrounding the intermediate opening 170. The modification recesses the intermediate opening 170. As a result, the outside opening 165 acts to shield the intermediate opening 170 from direct contact with the coking occurring within the engine cylinder. The modification should act to reduce and prevent coke from accumulating and obstructing the intermediate opening 170. The coke will more likely accumulate on the outside surface 155b of the wall 155 and on the increased surface area 168a of the frusto-conical section 168 before accumulating at the intermediate opening 170.

FIG. 5 illustrates another embodiment of a needle housing 120″ having a modified outside opening 265 of a nozzle hole 250. In this embodiment, the outside opening 265 is curved to form a semi-spherical section 268. The semi-spherical section 268 acts in a similar manner as the frusto-cone of the embodiment in FIG. 4. The geometry of the semi-sphere increases the diameter of the outside opening 265, creates an increased surface area 268a surrounding an intermediate opening 270, and acts to protect the intermediate opening from being in direct contact with the coking process, all of which should reduce and prevent the accumulation of coke at the intermediate opening 270.

FIG. 6 illustrates a still further embodiment nozzle hole 350. In this embodiment, an outside opening 365 has a straight taper to form a frusto-conical section 368. This new structure of the outside opening 365 increases the outside opening diameter compared to an intermediate opening 370 and creates a large surface area surrounding the intermediate opening 370. The modification recesses the intermediate opening 370. As a result, the outside opening 365 acts to shield the intermediate opening 370 from direct contact with the coking occurring within the engine cylinder. The modification should act to reduce and prevent coke from accumulating and obstructing the intermediate opening 370. The coke will more likely accumulate on the outside surface 155b of the wall 155 and on an increased surface area 368a of the section 368 before accumulating at the intermediate opening 370. According to this embodiment the frusto-conical section 368 smoothly curves into the intermediate opening and the outside opening.

The present invention is not limited to the geometric modifications for the outside openings 165, 265, 325 or inside opening as mentioned above. Other geometric modifications are contemplated, such as a double chamfer or double radius, etc.

According to the exemplary embodiments, the nozzle hole 150, 250 has a substantially constant opening size, such as a constant diameter for cylindrical holes, from the inside opening 160 to the intermediate opening 170, 270, 370 and a larger or an expanding opening from the intermediate opening 170, 270, 370 to the outside opening 165, 265, 365. However, the nozzle holes need not have a substantially constant opening size from the inside opening 160 to the intermediate opening 170, 270, 370, it could be tapered.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A fuel injector for injecting fuel into a cylinder of an internal combustion engine, comprising:
a valve housing having a surrounding wall;
an injector body that includes a needle valve within the valve housing;
a feed passage fluidly connecting the valve housing with a source of high pressure fuel; and
at least one hole through the surrounding wall having a first opening size within a thickness of the wall and a second opening size at an outside surface of the wall, where the second opening size is greater than the first opening size.

2. The fuel injector of claim 1, wherein the hole has a rounded inlet opening beginning at an inside surface of the surrounding wall and a rounded outlet opening beginning at the outside surface of the surrounding wall.

3. The fuel injector of claim 1, wherein the hole has a constant size from an inside surface of the surrounding wall to an intermediate position and an increased size from the intermediate position to the outside surface of the surrounding wall.

4. The fuel injector of claim 3, wherein the hole has a curved contour adjacent to the outside surface of the wall.

5. The fuel injector of claim 3, wherein the hole has a tapered contour adjacent to the outside surface of the wall.

6. The fuel injector of claim 1, wherein the hole has a tapered contour adjacent to the outside surface of the wall.

7. The fuel injector of claim 1, wherein the hole has an expanding size adjacent to the outside surface of the wall.

8. The fuel injector of claim 1, wherein the hole has a constant size from the inside of the wall to an intermediate position and an expanding size from the intermediate position to the outside surface of the wall.

9. A housing for a fuel injector for use with an internal combustion engine, comprising:
a fuel inlet near to one end of the housing and a tip portion extending from an intermediate position on the housing to an opposite end of the housing, wherein a plurality of holes are formed substantially radially through a wall of the housing within the tip portion;
a feed passage formed in the needle housing, wherein the feed passage fluidly connects the fuel inlet of the needle housing with the holes; and
the holes each have an increased cross-section adjacent an outside surface of the tip portion.

10. The needle housing of claim 9, wherein each hole has a rounded inlet opening beginning at an inside surface of the wall and extending inward.

11. The needle housing of claim 9, wherein each hole has a rounded outlet opening beginning at the outside surface of the wall and extending inward.

12. The needle housing of claim 9, wherein each hole has a substantially constant diameter from the inside of the wall to an intermediate position and an increasing diameter from the intermediate position to the outside of the wall.

13. The needle housing of claim 12, wherein each hole has a curved contour adjacent the outside surface of the wall.

14. The needle housing of claim 12, wherein each hole has a tapered contour adjacent the outside surface of the wall.

15. The needle housing of claim 9, wherein each hole has a curved contour adjacent the outside surface of the wall.

16. The needle housing of claim 9, wherein each hole has a tapered contour adjacent the outside surface of the wall.

17. A fuel injector for injecting fuel into a cylinder of an internal combustion engine, for use in an engine operated in an increased coking mode, comprising:
a valve housing having a surrounding wall;
an injector body that includes a needle valve within the valve housing;
a feed passage fluidly connecting the valve housing with a source of high pressure fuel; and
at least one hole through the surrounding wall having a first opening size within a thickness of the wall and a second opening size at an outside surface of the wall, where the second opening size is greater than the first opening size.

18. The fuel injector according to claim 17, wherein the engine is operated with an increased exhaust gas recirculation.

19. The fuel injector according to claim 17, wherein the engine is operated with a decreased intake manifold temperature.

20. The fuel injector according to claim 17, wherein the engine is operated with an increased concentration of additives for low sulfur fuels.
